(19) United States
(12) Patent Application Publication
(10) Pub. No.: US 2017/0146229 A1
(43) Pub. Date: May 25, 2017

(54) MULTI-SIDED CANDLE UNIT

(71) Applicant: K3 Enterprises, Inc., Miami, FL (US)

(72) Inventor: William C. Kercher, III, Miami, FL (US)

(21) Appl. No.: 14/950,235

(22) Filed: Nov. 24, 2015

(51) Int. Cl. F21V 35/00; C11C 5/00

(52) U.S. Cl. CPC F21V 35/00; C11C 5/002; C11C 5/004

(57) ABSTRACT

A candle unit including multiple candle characteristics, such as multiple candle colors and/or multiple candle scents. The candle unit is specifically configured and adapted to be invertible/repositionable, such that when the candle unit is in a first orientation, a first characteristic is perceptible, and when the candle unit is in an inverted, second orientation, a second characteristic is perceptible. Thus, the user may effectively change the characteristics of the candle unit simply by inverting/transitioning the candle unit between different operative orientations, as opposed to swapping out the candle unit for a different candle unit.

### CROSS-REFERENCE TO RELATED APPLICATIONS

Not Applicable

### STATEMENT RE: FEDERALLY SPONSORED RESEARCH/DEVELOPMENT

Not Applicable

### BACKGROUND

1. Technical Field

The present disclosure relates generally to a candle unit, and more specifically, to a candle unit having multiple candles arranged such that the candle unit can be selectively inverted, flipped, or otherwise transitioned between at least two different configurations to more prominently display and use at least one of the candles.

2. Description of the Related Art

Candles are well known and have been used extensively for lighting, ornamental effect, aromatherapy, and ceremonial purposes. A typical candle includes an ignitable wick embedded in a wax material. The wax material typically defines a color and scent which is emitted when the wick is ignited and burns.

In many instances, a single candle is associated with a single color and also a single scent. Common scents include cinnamon, vanilla, floral scents, fruit scents, seasonal scents, etc. In view of the numerous colors and scents associated with different candles, consumers oftentimes desire a variety of color and/or scents, which typically cannot be accommodated by a single candle and thus, consumers may purchase several candles which are different colors, scents, shapes, etc.

Although buying several different candles provides additional variety, there are drawbacks associated therewith. For instance, the individual may not be able to use all of the candles at once, and thus, the individual may be required to store several candles during periods of nonuse. In many cases, the additional storage space available to the individual may be limited, and thus, the user may be restricted to the number and variety of candles which can be stored. Additionally, when the user wants to use a candle that is being stored, the user must retrieve the candle from storage, and in some cases, place another candle back in storage. This tends to be tedious, and in many instances, the user will forego swapping out the candles and just settle on the candle currently displayed.

Accordingly, there is a need in the art for a candle unit that allows for ease in varying the candle(s) displayed by a user. Various aspects of the present disclosure address this particular need, as will be discussed in more detail below.

### BRIEF SUMMARY

In accordance with one embodiment of the present disclosure, there is depicted a candle unit including multiple candle characteristics, such as multiple candle colors and/or multiple candle scents. The candle unit is specifically configured and adapted to be invertible/repositionable, such that when the candle unit is in a first orientation, a first characteristic is perceptible, and when the candle unit is in an inverted, second orientation, a second characteristic is perceptible. Thus, the user may effectively change the characteristics of the candle unit simply by inverting/transitioning the candle unit between different operative orientations, as opposed to swapping out the candle unit for a different candle unit.

According to one embodiment, there is provided a candle unit adapted for use on an underlying support surface in at least two different orientations. The candle unit includes a dividing wall, as well as first and second support surfaces, each being spaced from the dividing wall and located on opposed sides of the dividing wall. A first peripheral wall extends from the dividing wall in a first direction and terminates to define at least a portion of the first support surface. The first peripheral wall and dividing wall collectively define a first recess. A first candle body is located within the first recess. A second peripheral wall extends from the dividing wall in a second direction opposite the first direction and terminates to define at least a portion of the second support surface. The second peripheral wall and dividing wall collectively define a second recess. A second candle body is located within the second recess. The candle unit is selectively transitional between a first orientation and a second orientation. In the first orientation, the second support surface faces toward the underlying support surface and the first support surface faces away from the underlying support surface to enable exposure of the first candle body. In the second orientation, the first support surface faces toward the underlying support surface and the second support surface faces away from the underlying support surface to enable exposure of the second candle body.

The first peripheral wall may be disposed about a first axis to define a circular configuration. The second peripheral wall may be disposed about a second axis substantially coaxially aligned with the first axis.

The first candle body defines a first color and the second candle body defines a second color different from the first color. The first candle body may be adapted to emit a first scent and the second candle body may be adapted to emit a second scent different from the first scent.

The first candle body and the second candle body may both be made of wax.

The candle unit may further include a first wick located within the first candle body and a second wick located in the second candle body.

The candle unit may additionally comprise a third peripheral wall extending from the dividing wall in the first direction and terminating to define at least a portion of the first support surface, the third peripheral wall and dividing wall collectively defining a third recess. A fourth peripheral wall may extend from the dividing wall in the second direction and terminate to define at least a portion of the second support surface, with the fourth peripheral wall and dividing wall collectively defining a fourth recess.

According to another embodiment, there is provided an invertible candle unit adapted for use on an underlying support surface in multiple configurations. The invertible candle unit includes a first support surface adapted to be disposable adjacent the underlying support surface for supporting the candle unit in a first orientation. The candle unit further includes a second support surface adapted to disposable adjacent the underlying support surface for supporting the candle unit in a second orientation inverted relative to the first orientation. A first holder body defines a first recess and at least a portion of the first support surface. A second holder body defines a second recess and at least a portion of the second support surface. A first candle body is located within the first recess and a second candle body located within the second recess.

According to yet another embodiment, there is provided a multi-sided candle unit adapted for use with an underlying support surface, the multi-sided candle unit includes a candle body having a plurality of outer surfaces angularly offset from each other, and a plurality of recesses extending into the candle body from respective ones of the plurality of outer surfaces, with the plurality of recesses being spaced from each other. A plurality of candles are located in respective ones of the plurality of recesses. The candle body is selectively positionable over the underlying support surface in a plurality of different orientations, with each orientation being associated with a different outer surface facing toward the underlying support surface.

The plurality of outer surfaces may collectively form a polyhedron.

The present disclosure will be best understood by reference to the following detailed description when read in conjunction with the accompanying drawings.

### BRIEF DESCRIPTION OF THE DRAWINGS

These and other features and advantages of the various embodiments disclosed herein will be better understood with respect to the following description and drawings, in which:

FIG. 1 is an upper perspective view of a first embodiment of a candle unit adapted to be invertible between two orientations;

FIG. 2 is an upper perspective view of the candle unit depicted in FIG. 1, with a pair of candles being exploded from the candle holder;

FIG. 3 is a side sectional view of the candle unit depicted in FIG. 1;

FIG. 4 is a top view of a second embodiment of a candle unit adapted to be invertible between two orientations;

FIG. 5 is a side sectional view of the candle unit depicted in FIG. 4;

FIG. 6 is a top view of a third embodiment of a candle unit adapted to be invertible between two orientations;

FIG. 7 is a side sectional view of the candle unit depicted in FIG. 6;

FIG. 8 is a perspective view of a six-sided candle unit; and

FIGS. 9 and 10 are perspective view of different candle units each forming a polyhedron with a different number of sides.

Common reference numerals are used throughout the drawings and the detailed description to indicate the same elements.

### DETAILED DESCRIPTION

The detailed description set forth below in connection with the appended drawings is intended as a description of certain embodiments of a candle unit and is not intended to represent the only forms that may be developed or utilized. The description sets forth the various structure and/or functions in connection with the illustrated embodiments, but it is to be understood, however, that the same or equivalent structure and/or functions may be accomplished by different embodiments that are also intended to be encompassed within the scope of the present disclosure. It is further understood that the use of relational terms such as first and second, and the like are used solely to distinguish one entity from another without necessarily requiring or implying any actual such relationship or order between such entities.

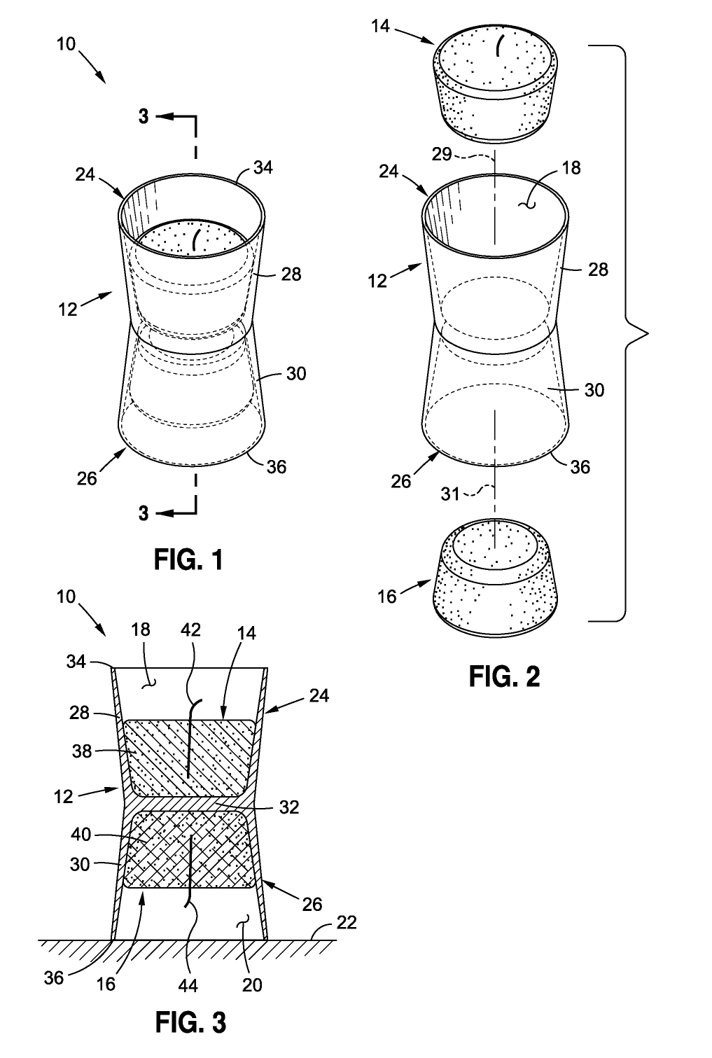

Referring now to FIGS. 1-3, there is depicted a first embodiment of a candle unit 10, which generally includes a candle holder 12 and a pair of candles 14, 16 which are located within respective recesses 18, 20 formed in the candle holder 12. The candle unit 10 is adapted for use on an underlying support surface 22 in at least two different orientations. A first orientation is shown in FIG. 3, with a first candle 14 being positioned for use and the second candle 16 being positioned under the first candle 14 and positioned between the candle holder 12 and the underlying support surface 22. However, the candle unit 10 may be easily inverted to swap the positions of the first and second candles 14, 16. In particular, when the candle unit 10 is in the second position, the second candle 16 is positioned for use and the first candle 14 is positioned under the second candle 16 and between the candle holder 12 and the underlying support surface 22. Therefore, the candle unit 10 serves multiple purposes, as it allows a user to quickly and easily swap one candle for another, thereby changing the characteristics of the displayed candle, such as the scent and color of the candle being burned. The candle unit 10 also allows for convenience storage or placement.

According to one embodiment, the candle unit 10 includes a first holder body 24 and a second holder body 26. In the exemplary embodiment, the first and second holder bodies 24, 26 are integrally coupled to each other to define a single unit, although it is contemplated that in other embodiments, the first holder body 24 may be detachably coupled to the second holder body 26, such as via a cooperative threaded engagement, or through the use of magnets or other mechanical fasteners known in the art. The first holder body 24 includes a first peripheral wall 28 disposed about a first axis 29, and the second holder body 30 includes a second peripheral wall 30 disposed about a second axis 31, with the first and second peripheral walls 28, 30 being minor images of each other. A dividing wall 32 extends between the first and second recesses 18, 20, such that the first recess 18 is collectively defined by the dividing wall 32 and the first peripheral wall 28 and the second recess 20 is collectively defined by the dividing wall 32 and the second peripheral wall 30. The first peripheral wall 28 extends from the dividing wall 32 in a first direction and terminates to define a first support surface 34, while the second peripheral wall 30 extends from the dividing wall 32 in a second direction and terminates to define a second support surface 36. As will be explained in more detail below, the first and second support surfaces 34, 36 are configured to individually support the candle unit 10 on the underlying support surface 22.

The first and second holder bodies 24, 26 may take on various shapes and sizes. In the exemplary embodiment depicted in FIGS. 1-3, the first and second peripheral walls 28, 30 define a tapered, cylindrical configuration, with the diameter of each peripheral wall 28, 30 being the smallest adjacent the dividing wall and increasing to a maximum diameter at the respective support surface 34, 36. Although the exemplary embodiment includes tapered peripheral walls 28, 30, it is contemplated that the candle unit 10 may include non-tapered peripheral walls 28, 30. Furthermore, while the holder bodies 24, 26 shown in FIGS. 1-3 include a circular cross sectional configuration, it is understood that the holder bodies may be quadrangular, triangular, polygonal, or any other shape or configuration known in the art.

The holder bodies 24, 26 may be made of any material known in the art that is commonly used in forming a candle holder. For instance, the holder bodies 24, 26 may be formed from glass, plastic, metal or other suitable materials. The holder bodies 24, 26 may be transparent, opaque, frosted, stained, etched, or have other finishes applied thereto.

Each candle 14, 16 includes a respective candle body 38, 40 and a wick 42, 44 extending through the corresponding candle body 38, 40. The candle bodies 38, 40 may be the same or different. For instance, the candle bodies 38, 40 may have different colors, different scents, different accents (e.g., items embedded within the candle wax), different wicks (e.g., string or wood), or other characteristics which may differ.

The candle unit 10 is selectively transitional between a first orientation and a second orientation, depending on which candle 14, 16 the user wants to more prominently feature or display. In the first orientation, which is shown in FIG. 3, the second support surface 36 faces the underlying support surface 22 and the first support surface 34 faces away from the support surface 22 to enable exposure of the first candle 14. When the candle unit 10 is in the first orientation, the support surface 22 effectively closes the second recess 20 so as to contain the second candle 16 therein. The candle unit 10 is adapted to be easily transitioned from the first orientation to the second orientation. In the second orientation, the first support surface 34 faces toward the underlying support surface 22 and the second support surface 36 faces away from the support surface 22 to enable exposure of the second candle 16. When the candle unit 10 is in the second orientation, the support surface 22 effectively closes the first recess 18 so as to contain the first candle 14 therein.

The ease in transitioning the candle unit 10 between the first and second orientations is as easy as inverting the candle unit 10 on the support surface 22. In this respect, the candle unit 10 is multi-functional, as it allows for display of one candle, along with simultaneous storage or containment of another candle at the same location. Therefore, the user is not required to store the other candle in a remote storage location.

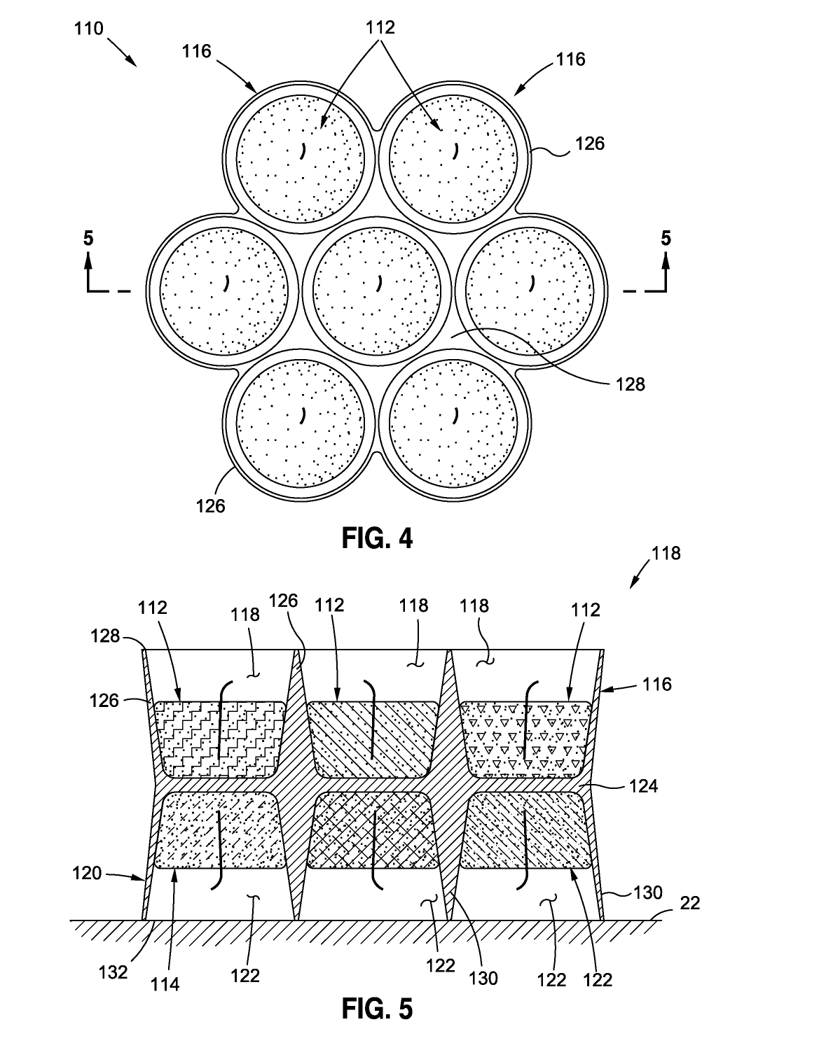

FIGS. 1-3 show the candle unit 10 as being two-sided, with one candle on each side. Referring now to FIGS. 4 and 5, there is depicted another embodiment of a candle unit 110 which is two-sided, but includes multiple candles on each side. The candle unit 110 is selectively transitional between first and second orientations, with the candles on a first side are exposed when the candle unit 110 is in the first orientation, and the candles on a second side are exposed when the candle unit 110 is in the second orientation.

The candle unit 110 includes seven first side candles 112 on a first side of the candle unit 110 and seven second side candles 114 on a second side of the candle unit 110. Each first side candle 112 is received within a respective first side holder body 116, with each first side holder body 116 defining a respective recess 118 adapted to receive one of the candles 112. Likewise, each second side candle 114 is received within a respective second side holder body 120, with each second side holder body 120 defining a respective recess 122 adapted to receive one of the candles 114.

In the embodiment depicted in FIG. 5, all of the holder bodies 116, 120 are integrally formed with each other to define a single unit. However, it is understood that the holder bodies 116, 120 may be detachably engaged with each other. For instance, the candle unit 110 may include a separating plate (not shown) to which the holder bodies 116, 120 may be detachably engaged.

A dividing wall 124 extends between the first and second recess 118, 122 and partially defines the recesses 118, 122. The recesses 118, 122 are further defined by a plurality of peripheral walls which extend from the dividing wall 124. In particular, a plurality of first side peripheral walls 126 extend from the dividing wall 124 in a first direction and terminate to collectively define a first support surface 128, while a plurality of second side peripheral walls 130 extend from the dividing wall 124 in a second direction and terminate to collectively define a second support surface 132.

The candle unit 110 is selectively transitional between a first orientation and a second orientation, depending on which set of candles 112, 114 the user wants to more prominently feature or display. In the first orientation, the second support surface 132 faces the underlying support surface 22 and the first support surface 128 faces away from the support surface 22 to enable exposure of the first set of candles 112. When the candle unit 110 is in the first orientation, the support surface 22 effectively closes the second recesses 122 so as to contain the second set of candles 114 therein. The candle unit 110 is adapted to be easily transitioned from the first orientation to the second orientation. In the second orientation, the first support surface 128 faces toward the underlying support surface 22 and the second support surface 132 faces away from the support surface 22 to enable exposure of the second set of candles 114. When the candle unit 110 is in the second orientation, the support surface 22 effectively closes the first recesses 118 so as to contain the first set of candles 112 therein.

The candle unit 110 may be desirable when the user wants to display a plurality, set, or grouping of candles at once. With a single flip or inversion of the candle unit 110, the user may change the candles displayed by the candle unit 110. As with the candle unit 10 discussed above, the candles included in candle unit 110 may be similar or different. For instance, the first set of candles 112 may be warm colors (red, orange, etc.), while the second set of candles 113 may be cool colors (blue, green, etc.). Furthermore, the scents may vary from one candle to the next.

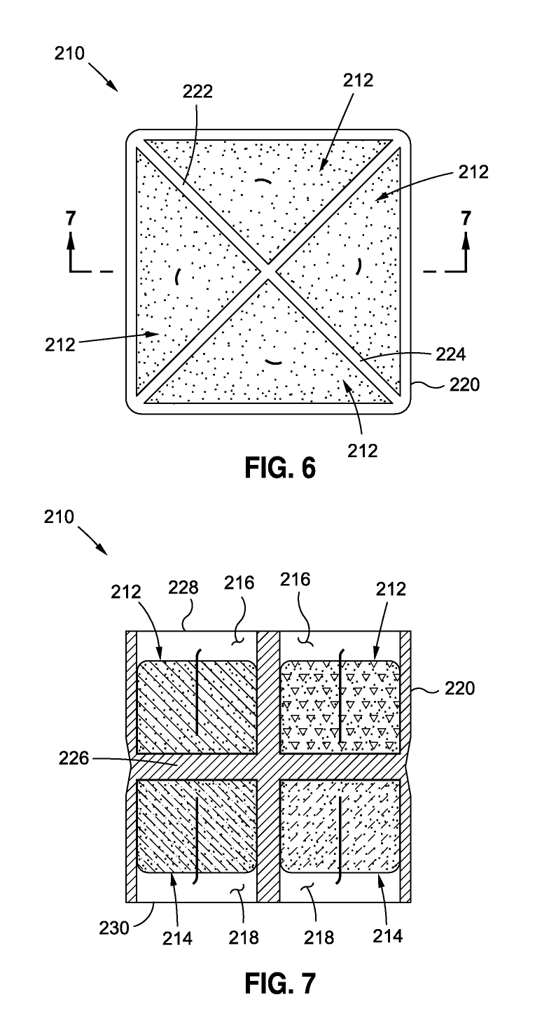

FIGS. 6 and 7 show a variation of a candle unit 210 which functions in a similar manner to the candle unit 110 discussed above. Therefore, the following discussion will focus on the unique features of the candle unit 210, which primarily relates to its shape. In particular, the candle unit 210 includes a plurality of first side candles 212 arranged on a first side of the candle unit 210 and a plurality of second side candles 214 arranged on a second side of the candle unit 210. Each first side candle 212 is located within a first side recess 216, and each second side candle 214 is located within a second side recess 218. From the perspective shown in FIG. 6, the candle unit 210 includes a quadrangular outer peripheral 220 and pair of diagonal walls 222, 224 extending between opposed corners of the peripheral wall 220 to define the triangular shaped recesses 216, 218. In this respect, portions of the outer peripheral wall 220 as well as portions of the diagonal walls 222, 224 define the peripheral walls of the respective recesses 216, 218. A dividing wall 226 extends between the recesses 216, 218 and further defines a portion of the recesses 216, 218.

The candle unit 210 includes opposed first and second support surfaces 228, 230 for supporting the candle unit 210 on an underlying support surface 22 in different orientations. In particular, second support surface 230 faces toward the underlying support surface 22 to place the candle unit 210 in a first orientation for exposing candles 212. Conversely, first support surface 228 faces toward the underlying support surface 22 to place the candle unit 210 in a second orientation for exposing candles 214.

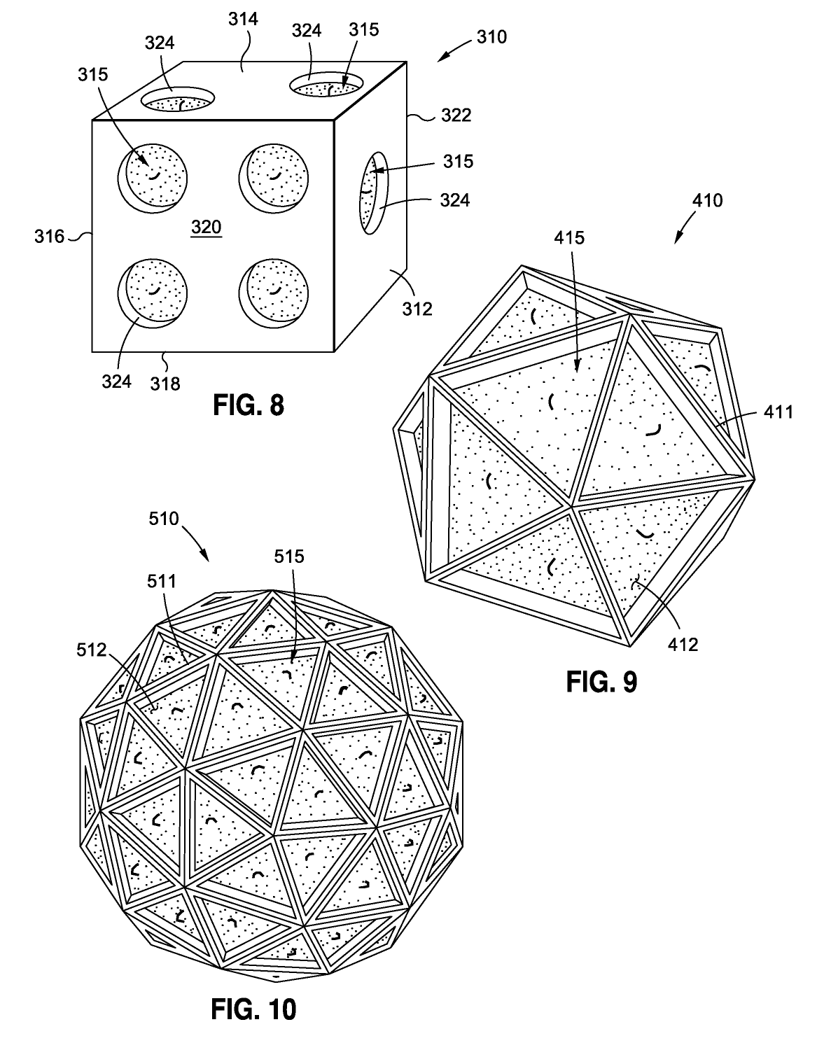

According to another embodiment, and referring now specifically to FIG. 8, there is depicted a candle unit 310 which is configured similar to a die (e.g., singular of dice), and thus, is of a cuboid shape, including six sides 312, 314, 316, 318, 320, 322. Each side 312, 314, 316, 318, 320, 322 includes a different number of recess(es) formed therein, with a candle 315 being located in each recess. In particular, a first side 312 includes one recess, a second side 314 includes two recesses, a third side 316 includes three recesses, a fourth side 320 includes four recesses, a fifth side 318 includes five recesses and a sixth side 322 includes six recesses. The recesses are arranged on the respective sides similar to the markings/dots on a conventional die. Each recess is defined by a peripheral wall 324 which extends into the candle unit 310 from the respective side.

The candle unit 310 may be placed in one of six different orientations, with each side 312, 314, 316, 318, 320, 322 being positionable in a direction facing an underlying support surface 22 when the candle unit 310 assumes the various orientations. In the embodiment depicted in FIG. 8, the candle unit 310 is oriented with side 318 facing downwardly (and presumably toward a support surface 22), with side 314 facing an upward direction. The side 314 includes two recesses, which correspond to the number 2 on a die.

The candle unit 310 differs from the previous candle units described above in that the previous candle units were two sided, and thus, one candle (or group of candles) was exposed, while the other candle (or group of candles) was concealed when the candle unit was in the first or second orientation. In contrast, the candle unit 310 includes several groups of candles which are exposed when the candle unit is in any one of the six different orientations, while only one group of candle(s) remains covered. For instance, in FIG. 8, side 318 is the only side which faces downwardly, and thus, the candles on sides 312, 314, 316, 320, and 322 may remain exposed.

Referring now to FIGS. 9 and 10, there is shown different embodiments of candle units 410, 510, each of which are polyhedrons (e.g., a three dimensional solid figure in which each side is a flat surface) generally resembles a spherical shape. In this respect, the term “spherical” is used broadly as the polyhedron candle units 410, 510 are not perfectly round, and rather, the outer periphery is defined by a plurality of generally planar surfaces. However, those planar surfaces are arranged in a generally spherical configuration, similar to a spherical ball. Each of the candle units 410, 510 is comprised of a plurality of triangular outer surfaces 411, 511 and triangular recesses 412, 512 extending into the candle unit 410, 510 from a respective triangular outer surface 411, 511. Each recess 412, 512 includes a candle 415, 515 located therein. As noted above in relation to the previously described candle units, the candles located in candle units 410, 510 may be the same or different. The primary difference between candle unit 410 and candle unit 510 is that candle unit 510 includes more recesses 512 than candle unit 410. The candle units 410, 510 may be supported by at least one of the triangular outer surfaces 411, 511. In this respect, the candle unit 410, 510 may be rolled or rotated to a desired position to display the candles 415, 515 which are preferred by the user.

The particulars shown herein are by way of example only for purposes of illustrative discussion, and are not presented in the cause of providing what is believed to be most useful and readily understood description of the principles and conceptual aspects of the various embodiments of the present disclosure. In this regard, no attempt is made to show any more detail than is necessary for a fundamental understanding of the different features of the various embodiments, the description taken with the drawings making apparent to those skilled in the art how these may be implemented in practice.

What is claimed is:

1. A candle unit adapted for use on an underlying support surface in at least two different orientations, the candle unit comprising:
a dividing wall;
a first support surface and a second support surface each being spaced from the dividing wall and located on opposed sides of the dividing wall;
a first peripheral wall extending from the dividing wall in a first direction and terminating to define at least a portion of the first support surface, the first peripheral wall and dividing wall collectively defining a first recess;
a first candle body located within the first recess;
a second peripheral wall extending from the dividing wall in a second direction opposite the first direction and terminating to define at least a portion of the second support surface, the second peripheral wall and dividing wall collectively defining a second recess; and
a second candle body located within the second recess;
the candle unit being selectively transitional between a first orientation and a second orientation,
in the first orientation, the second support surface facing toward the underlying support surface and the first support surface facing away from the underlying support surface to enable exposure of the first candle body,
in the second orientation, the first support surface facing toward the underlying support surface and the second support surface facing away from the underlying support surface to enable exposure of the second candle body.

2. The candle unit recited in claim 1, wherein the first peripheral wall is disposed about a first axis to define a circular configuration.

3. The candle unit recited in claim 1, wherein the first peripheral wall is disposed about a first axis and the second peripheral wall is disposed about a second axis substantially coaxially aligned with the first axis.

4. The candle unit recited in claim 1, wherein the first candle body defines a first color and the second candle body defines a second color different from the first color.

5. The candle unit recited in claim 1, wherein the first candle body is adapted to emit a first scent and the second candle body is adapted to emit a second scent different from the first scent.

6. The candle unit recited in claim 1, wherein the first candle body and the second candle body are both made of wax.

7. The candle unit recited in claim 1, further comprising a first wick located within the first candle body and a second wick located in the second candle body.

8. The candle unit recited in claim 1, further comprising a third peripheral wall extending from the dividing wall in the first direction and terminating to define at least a portion of the first support surface, the third peripheral wall and dividing wall collectively defining a third recess.

9. The candle unit recited in claim 8, further comprising a fourth peripheral wall extending from the dividing wall in the second direction and terminating to define at least a portion of the second support surface, the fourth peripheral wall and dividing wall collectively defining a fourth recess.

10. An invertible candle unit adapted for use on an underlying support surface in multiple configurations, the invertible candle unit comprising:
a first support surface adapted to be disposable adjacent the underlying support surface for supporting the candle unit in a first orientation;
a second support surface adapted to disposable adjacent the underlying support surface for supporting the candle unit in a second orientation inverted relative to the first orientation;
a first holder body defining a first recess and at least a portion of the first support surface;
a second holder body defining a second recess and at least a portion of the second support surface;
a first candle body located within the first recess; and
a second candle body located within the second recess.

11. The invertible candle unit recited in claim 10, wherein the first holder body is disposed about a first axis to define a circular configuration.

12. The invertible candle unit recited in claim 10, wherein the first holder body is disposed about a first axis and the second holder body is disposed about a second axis substantially coaxially aligned with the first axis.

13. The invertible candle unit recited in claim 10, wherein the first candle body defines a first color and the second candle body defines a second color different from the first color.

14. The invertible candle unit recited in claim 10, wherein the first candle body is adapted to emit a first scent and the second candle body is adapted to emit a second scent different from the first scent.

15. The invertible candle unit recited in claim 10, wherein the first candle body and the second candle body are both made of wax.

16. The invertible candle unit recited in claim 10, further comprising a first wick located within the first candle body and a second wick located in the second candle body.

17. The invertible candle unit recited in claim 10, further comprising a third peripheral wall extending from the dividing wall in the first direction and terminating to define at least a portion of the first support surface, the third peripheral wall and dividing wall collectively defining a third recess.

18. The invertible candle unit recited in claim 17, further comprising a fourth peripheral wall extending from the dividing wall in the second direction and terminating to define at least a portion of the second support surface, the third peripheral wall and dividing wall collectively defining a fourth recess.

19. A multi-sided candle unit adapted for use with an underlying support surface, the multi-sided candle unit comprising:
a candle body having a plurality of outer surfaces angularly offset from each other;
a plurality of recesses extending into the candle body from respective ones of the plurality of outer surfaces, the plurality of recesses being spaced from each other; and
a plurality of candles located in respective ones of the plurality of recesses;
the candle body being selectively positionable over the underlying support surface in a plurality of different orientations, each orientation being associated with a different outer surface facing toward the underlying support surface.

20. The multi-sided candle unit recited in claim 19, wherein the plurality of outer surfaces collectively form a polyhedron.
